(19) United States
(12) Patent Application Publication
(10) Pub. No.: US 2026/0296650 A1
(43) Pub. Date: Oct. 1, 2026

(54) TURBINE AIR SEGREGATION AIR CYCLE SYSTEM

(71) Applicant: Hamilton Sundstrand Corporation, Charlotte, NC (US)

(72) Inventors: Xiaohong Liao, Andover, CT (US); Jeffrey Ernst, Wethersfield, CT (US); Lance R. Bartosz, Granby, MA (US); Henry Hsin-Cheng Wu, Longmeadow, MA (US); Donald E. Army, Enfield, CT (US)

(21) Appl. No.: 19/570,540

(22) Filed: Mar. 18, 2026

Related U.S. Application Data
(60) Provisional application No. 63/779,711, filed on Mar. 28, 2025.

(51) Int. Cl. B64D 13/08; B64D 13/06

(52) U.S. Cl. CPC B64D 13/08; B64D 2013/0614; B64D 2013/0648; B64D 2013/0662

(57) ABSTRACT

An environmental control system of a vehicle includes an inlet configured to receive a medium, an outlet for receiving a conditioned form of the medium. A first portion of the medium at the outlet is to be provided to a cabin of the vehicle, and a thermodynamic device is in fluid communication with the inlet. The thermodynamic device includes a compressor, a first turbine, and a second turbine, operably coupled by a shaft. At least a portion of the medium is provided to the compressor, the first turbine and the second turbine in series. An air-liquid heat exchanger is positioned fluidly downstream of the second turbine such that the medium output from the second turbine exchanges thermal energy with a flow of liquid at the liquid-air heat exchanger. The first portion of the medium is output to the cabin downstream of the liquid-air heat exchanger.

### CROSS REFERENCE TO RELATED APPLICATIONS

The present application claims the benefit of U.S. Provisional Patent Application Ser. No. 63/779,711 filed Mar. 28, 2025, the entire contents of which are incorporated herein by reference thereto.

### BACKGROUND

Embodiments of the disclosure relate to environmental control systems, and more specifically to an environmental control system of an aircraft.

Contemporary aircraft have bleed air systems that take hot air from the engines of the aircraft for use in other systems on the aircraft including environmental control systems (ECS) such as air-conditioning, pressurization, and de-icing. The ECS can include limits on the pressure or temperature of the bleed air received from the bleed air systems. Currently, aircraft engine bleed systems draw air having a pressure far exceeding the pressure demand of a load, such as more than 80 psig for example. By drawing air at such high temperatures and pressures, enough expansion of the airflow may be performed to achieve sufficient cooling capacity. Existing ECS architectures are not suitable for use with airflows having a significantly reduced pressure.

### SUMMARY

In one exemplary embodiment, an environmental control system of a vehicle includes an inlet configured to receive a medium, an outlet for receiving a conditioned form of the medium, wherein a first portion of the conditioned form of the medium at the outlet is to be provided to a cabin of the vehicle, and a thermodynamic device in fluid communication with the inlet. The thermodynamic device includes a compressor, a first turbine, and a second turbine. The compressor, the first turbine and the second turbine are operably coupled by a shaft. The compressor, the first turbine and the second turbine are fluidly connected such that at least a portion of the medium is provided to the compressor, the first turbine and the second turbine in series. An air-liquid heat exchanger is positioned fluidly downstream of the second turbine such that the medium output from the second turbine exchanges thermal energy with a flow of liquid at the liquid-air heat exchanger. The first portion of the medium is output to the cabin downstream of the liquid-air heat exchanger.

Additionally or alternatively, in this or other embodiments the outlet and the second turbine are arranged in parallel relative to a flow of the medium, and the flow of the medium at a location downstream from the second turbine is configured as a heat sink to cool the medium to be provided to the cabin.

Additionally or alternatively, in this or other embodiments a second portion of the medium is output to one or more vehicle loads.

Additionally or alternatively, in this or other embodiments a recirculation passage is configured to direct at least a portion of the first portion of the medium from the cabin to the one or more vehicle loads.

Additionally or alternatively, in this or other embodiments a heat exchanger is positioned fluidly downstream of the compressor and upstream of the first turbine, such that the medium exiting the compressor exchanger is directed through the heat exchanger for thermal energy exchange with a second medium.

Additionally or alternatively, in this or other embodiments one of a fan or an ejector is configured to urge the second medium across the heat exchanger.

Additionally or alternatively, in this or other embodiments the system includes a regeneration heat exchanger through which the medium is directed. The regeneration heat exchanger is positioned fluidly downstream of at least the heat exchanger.

Additionally or alternatively, in this or other embodiments the regeneration heat exchanger is positioned fluidly between the first turbine and the second turbine.

Additionally or alternatively, in this or other embodiments a first portion of the medium output from the regeneration heat exchanger is directed to the second turbine, and a second portion of the medium output from the regeneration heat exchanger is directed to the cabin via a cabin heat exchanger.

Additionally or alternatively, in this or other embodiments a water extractor is positioned between the first turbine and the second turbine.

Additionally or alternatively, in this or other embodiments a first turbine bypass passage is configured to selectably direct the medium to bypass the first turbine, and a second turbine bypass passage is configured to selectably direct the medium to bypass the second turbine.

In another exemplary embodiment, a method of operating an environmental control system of a vehicle includes receiving a medium at an inlet, and directing the medium from the inlet through a thermodynamic device in fluid communication with the inlet. The thermodynamic device includes a compressor, a first turbine, and a second turbine. The compressor, the first turbine and the second turbine are operably coupled by a shaft. At least a portion of the medium is provided to the compressor, the first turbine and the second turbine in series. The medium output from the second turbine is thermally conditioned at an air-liquid heat exchanger positioned fluidly downstream of the second turbine such that the medium output from the second turbine exchanges thermal energy with a flow of liquid at the liquid-air heat exchanger. The first portion of the medium is output to the cabin downstream of the liquid-air heat exchanger.

Additionally or alternatively, in this or other embodiments the medium is divided such that a first portion of the medium is provided to an outlet and a second portion of the medium is provided to a turbine in parallel, and the first portion of the medium is cooled with the second portion of the medium at a location downstream from the turbine.

Additionally or alternatively, in this or other embodiments a second portion of the medium is output to one or more vehicle loads.

Additionally or alternatively, in this or other embodiments at least a portion of the first portion of the medium is directed from the cabin to the one or more vehicle loads via a recirculation passage.

Additionally or alternatively, in this or other embodiments the medium is directed through a heat exchanger positioned fluidly downstream of the compressor and upstream of the first turbine, such that the medium exiting the compressor exchanger is directed through the heat exchanger for thermal energy exchange with a second medium.

Additionally or alternatively, in this or other embodiments the second medium is urged across the heat exchanger via one of a fan or an ejector.

Additionally or alternatively, in this or other embodiments the medium is directed through a regeneration heat exchanger. The regeneration heat exchanger is positioned fluidly downstream of at least the heat exchanger.

Additionally or alternatively, in this or other embodiments the regeneration heat exchanger is positioned fluidly between the first turbine and the second turbine.

Additionally or alternatively, in this or other embodiments a first portion of the medium output from the regeneration heat exchanger is directed to the second turbine, a second portion of the medium output from the regeneration heat exchanger is directed to the cabin via a cabin heat exchanger.

### BRIEF DESCRIPTION OF THE DRAWINGS

The subject matter is particularly pointed out and distinctly claimed in the claims at the conclusion of the specification. The forgoing and other features, and advantages thereof are apparent from the following detailed description taken in conjunction with the accompanying drawings in which:

FIG. 1 is a schematic diagram of an exemplary embodiment of an environmental control system;

FIG. 2 is a schematic diagram of another exemplary embodiment of an environmental control system;

FIG. 3 is a schematic diagram of still another exemplary embodiment of an environmental control system; and

FIG. 4 is a schematic diagram of yet another exemplary embodiment of an environmental control system.

### DETAILED DESCRIPTION

A detailed description of one or more embodiments of the disclosed apparatus and method are presented herein by way of exemplification and not limitation with reference to the FIGS.

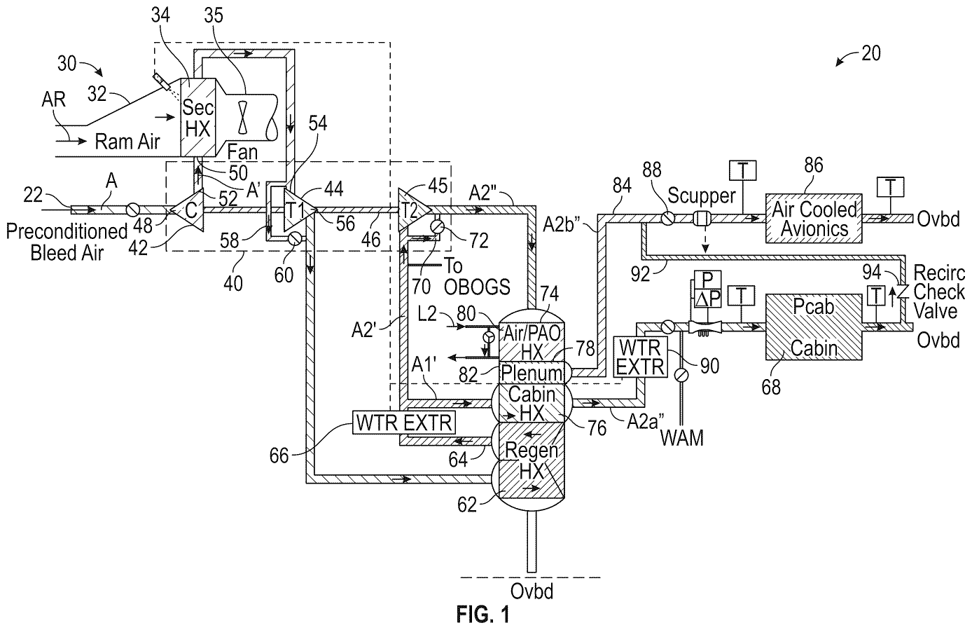

With reference now to the FIG. 1, a schematic diagram of a portion of an environment control system (ECS) 20, such as an air conditioning unit or pack for example, is depicted according to a non-limiting embodiment. Although the environmental control system or ECS pack 20 is described with reference to an aircraft, alternative applications, such as another vehicle for example, are also within the scope of the disclosure. As shown, the ECS 20 may be configured to receive a medium A at an inlet 22 and may provide a conditioned form of the medium A to loads during normal operation. In embodiments where the ECS 20 is used in an aircraft application, the medium A may be bleed air, which is pressurized air originating from i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn. In an embodiment, only a conditioned form of the medium A is provided at an outlet of the ECS 20 to the one or more loads.

The environmental control system 20 may include a ram air circuit 30 including a shell or duct, illustrated schematically at 32, within which a ram air heat exchanger 34 is located. The shell 32 can receive and direct a medium, such as ram air AR for example, across the heat exchanger 34. The ram air heat exchanger 34 is a device built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers. In the embodiment of FIG. 1, a fan 35 is disposed in the shell 32 and is selectably operable to urge the medium AR across the ram air heat exchanger 34 in certain operating conditions. Within the ram air heat exchanger 34, the ram air AR acts as a heat sink to cool a medium passing there through, for example the medium A, which in some embodiments is a preconditioned bleed air.

The ECS 20 additionally includes at least one thermodynamic device 40. Each thermodynamic device 40 is a mechanical device that includes components for performing thermodynamic work on a medium (e.g., extracts work from or applies work to the first medium A, by raising and/or lowering pressure and by raising and/or lowering temperature). Examples of a thermodynamic device include an air cycle machine, a two-wheel air cycle machine, a three-wheel air cycle machine, a four-wheel air cycle machine, etc. In the illustrated, non-limiting embodiments, the ECS 20 includes a compressor 42, a first turbine 44, and a second turbine 45 arranged along a shaft 46. In such embodiments, energy extracted from the medium A within the turbines 44 and 45 may be used to drive the compressor 42.

The compressor 42 is a mechanical device configured to raise a pressure of a medium and can be driven by another mechanical device (e.g., a motor or a medium via a turbine). Examples of compressor types include centrifugal, or mixed-flow, axial-flow, rotary screw, scroll, etc. The turbines 44 and 45 are mechanical devices that expand a medium and extract work therefrom (also referred to as extracting energy). This extracted energy is transmitted to the shaft 46 of the turbine 44 and 45, and the other components operably coupled thereto, such as the compressor 42 for example.

As shown, the medium A provided at the inlet 22 is provided to a compressor inlet 48 of the compressor 42, where the compressor 42 heats and increases the pressure of the medium A to form a compressed medium A′. A heat exchanger inlet 50 of the heat exchanger 34 is arranged downstream from and is fluidly connected to a compressor outlet 52 of the compressor 42. The compressed medium A′ output from the compressor 42 is cooled within the heat exchanger 34. The cooled compressed medium A′ is then directed to a first turbine inlet 54 of the first turbine 44, where the medium A′ is expanded, exiting the first turbine 44 at a first turbine outlet 56. In some embodiments, the compressed medium A′ may be selectably directed to bypass the first turbine 44 and flow along a first turbine bypass passage 58. The flow of compressed medium A′ through the first turbine bypass passage 58 may be controlled by a first turbine bypass valve 60 positioned along the first turbine bypass passage 58.

In an embodiment, a regeneration heat exchanger 62 is arranged downstream from the first turbine 44. The compressed medium A′ output from the first turbine 44 and/or the first turbine bypass passage 58 may be further cooled within the regeneration heat exchanger 62. In the illustrated, non-limiting embodiment, the secondary fluid used to cool the compressed medium A′ within the regeneration heat exchanger 62 is a portion of the flow of the medium A′ output from the regeneration heat exchanger 62, as will be described in more detail below. Within the regeneration heat exchanger 62, the compressed medium A′ may be cooled such that moisture therein condenses. From the outlet 64 of the regeneration heat exchanger 62, the wet compressed medium A′ may be provided to a water extractor 66 to remove any free moisture therefrom, and the condensate can be sprayed onto heat exchanger 34 or regeneration heat exchanger 62 for more cooling capacity.

As shown, in an embodiment, the flow of compressed medium A′ at a location downstream from the water extractor 66 is split into a first portion A1′ ultimately to be provided to a cabin 68 and a second portion A2′ to be used to condition the first portion A1′. From the water extractor 66, the second portion A2′ of the compressed medium A′ may be provided to the second turbine 45 of the thermodynamic device 40. Within the second turbine 45, energy extracted from the second portion A2′ of the compressed medium A′ is used to drive the compressor 42 and the first turbine 44 via the shaft 46. Accordingly, the both the pressure and the temperature of the second portion A2′ of the compressed medium is reduced at the second turbine turbine 45 to form an expanded medium A2″. As with the first turbine 44, the second portion A2′ may be selectably directed along a second turbine bypass passage 70 to bypass the second turbine 45. The flow of the second portion A2′ along the second turbine bypass passage 70 is controlled by operation of a second turbine bypass valve 72 located along the second turbine bypass passage 70.

In an embodiment, an air-liquid heat exchanger 74 is located downstream from the second turbine 45 relative to the flow of the expanded medium A2″. A2″ has the coldest temperature of the entire embodiment, so it can be used to cool all kinds of loads of the vehicle, such as cabin, power electronics, etc. At the air-liquid heat exchanger 74, the expanded medium A2″ is arranged in a heat transfer relationship with another liquid L2, PAO for example, provided from another liquid loop, such as used to cool one or more loads of the vehicle.

Regardless of the source of the liquid L2, within the air-liquid heat exchanger 74, thermal energy is transferred between the expanded medium A2″ and the liquid L2. In an embodiment, the expanded medium A2″ is heated by the liquid L2 and the resulting cooler liquid L2 may then be directed to one or more heat loads of the liquid loop.

A cabin heat exchanger 76, such as used to condition the flow of medium provided to the cabin 68 for example, may be located downstream from the air-liquid heat exchanger 74 relative to the flow of the expanded medium A2″. An inlet 78 of the cabin heat exchanger 76 may be fluidly connected directly to an outlet 80 of the air-liquid heat exchanger 74. However, in some embodiments, the cabin heat exchanger 76 is physically spaced from the air-liquid heat exchanger 74 such that a gap or plenum 82 exists between the air-liquid heat exchanger 74 and the cabin heat exchanger 76.

The heated expanded medium A2″ provided at the outlet 80 of the air-liquid heat exchanger 74 into the plenum 82 upstream from the cabin heat exchanger 76 may be divided into multiple flows, as shown in the FIGS. A first portion A2a″ of the expanded medium may be provided to the cabin heat exchanger 76. In such embodiments, a conduit 84 may fluidly couple the plenum 82 and one or more loads 86 of the aircraft requiring cooling, such as air-cooled avionics for example such as via another outlet. A second portion A2b″ of the expanded medium may be delivered to the one or more loads 86 via the conduit 84. In an embodiment, a plenum valve 88 is arranged within the conduit 84 to selectively control the flow of the second portion A2b″ of the expanded medium, if any, provided to the one or more loads 86. However, it should be understood that embodiments where the heated expanded medium A2″ provided at the outlet 80 of the air-liquid heat exchanger 74 is not divided, and therefore the entire flow thereof is provided to the cabin heat exchanger 76, are also contemplated herein.

Within the cabin heat exchanger 76, the first portion A2a″ of the expanded medium is arranged in a heat exchange relationship with the first portion A1′ of the compressed medium output from the water extractor 66. In an embodiment, heat from the first portion A1′ of the compressed medium is transferred to the first portion A2a″ of the expanded medium to cool the first portion A1′ of the compressed medium to a desired temperature. The first portion A1′ of the compressed medium output from the cabin heat exchanger 76 may then be provided to the cabin 68. In an embodiment, the first portion A1′ of the compressed medium output from the cabin heat exchanger 76 is configured to pass through a second water extractor 90 to remove any free moisture therefrom before being delivered to the cabin 68.

A second inlet of the regeneration heat exchanger 62 may be fluidly connected to an outlet of the cabin heat exchanger 76 such that the first portion A2a″ of the expanded medium output from the cabin heat exchanger 76 is provided to the cabin heat exchanger 76 and the regeneration heat exchanger 62 in series. As shown, in an embodiment, the second inlet of the regeneration heat exchanger 62 is located directly downstream from the cabin heat exchanger 76 relative to the flow of the first portion A2a″ of the expanded medium. Further, the cabin heat exchanger 76 may be mounted directly adjacent to the regeneration heat exchanger 62. As previously noted, within the regeneration heat exchanger 62, the first portion A2a″ of the expanded medium is configured to absorb heat from the compressed medium A1′. The outlet of the second pass of the regeneration heat exchanger 62 may be fluidly connected to the atmosphere outside of the aircraft such that the heated first portion A2a″ of the expanded medium output therefrom may be exhausted overboard.

In the various environmental control systems shown in the illustrated, non-limiting embodiments, energy is not extracted from the flow of medium that is ultimately provided to the cabin 68. Accordingly, the pressurized and conditioned medium provided to the cabin 68 is drawn from a location upstream of the second turbine 45 such that the medium delivered to the cabin 68 was not provided to the second turbine 45 of the thermodynamic device 40.

In some embodiments, outflow of medium from the cabin 68 may be exhausted overboard, or may alternatively be recirculated to the one or more loads 86 due to the relatively high pressure of the cabin 68 relative to the one or more loads 86. Thus, a recirculation passage 92 is provided to direct the outflow from the cabin 68 to the conduit 84, upstream of the one or more loads 86. A recirculation check valve 94 is located along the recirculation passage 92 to prevent backflow of medium from passage 84 along the recirculation passage 92.

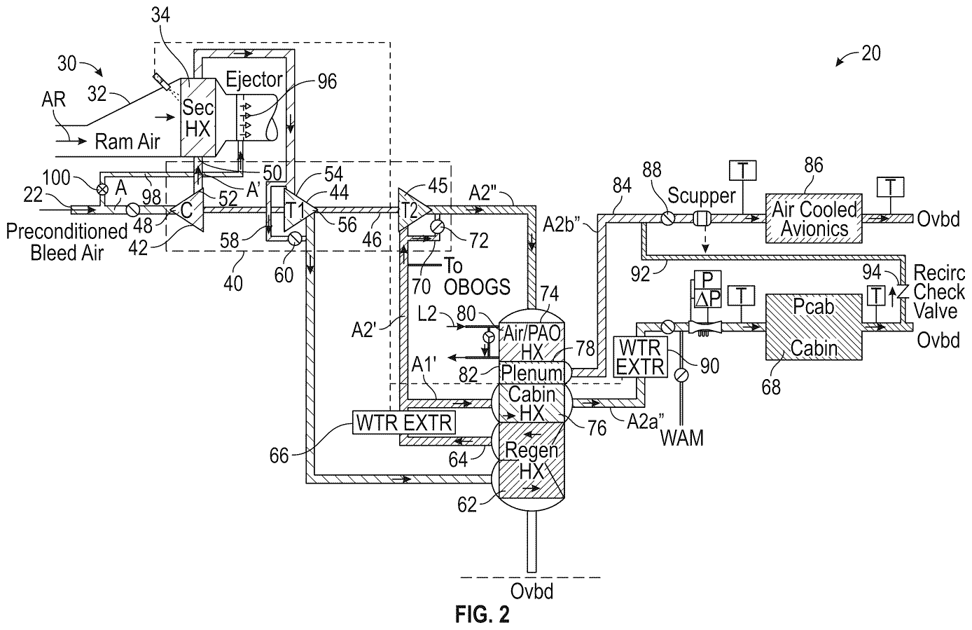

Referring now to FIG. 2, the ECS 20 operates substantially similarly to the system of FIG. 1. However, in the system of FIG. 2, an ejector 96 is disposed in the shell 32 and is selectably operable to urge the medium AR across the ram air heat exchanger 34 in certain operating conditions. The ejector 96 utilizes a flow of medium A diverted from the inlet 22 upstream of the compressor 42 along an ejector passage 98. An ejector valve 100 controls the flow of medium A along the ejector passage 98.

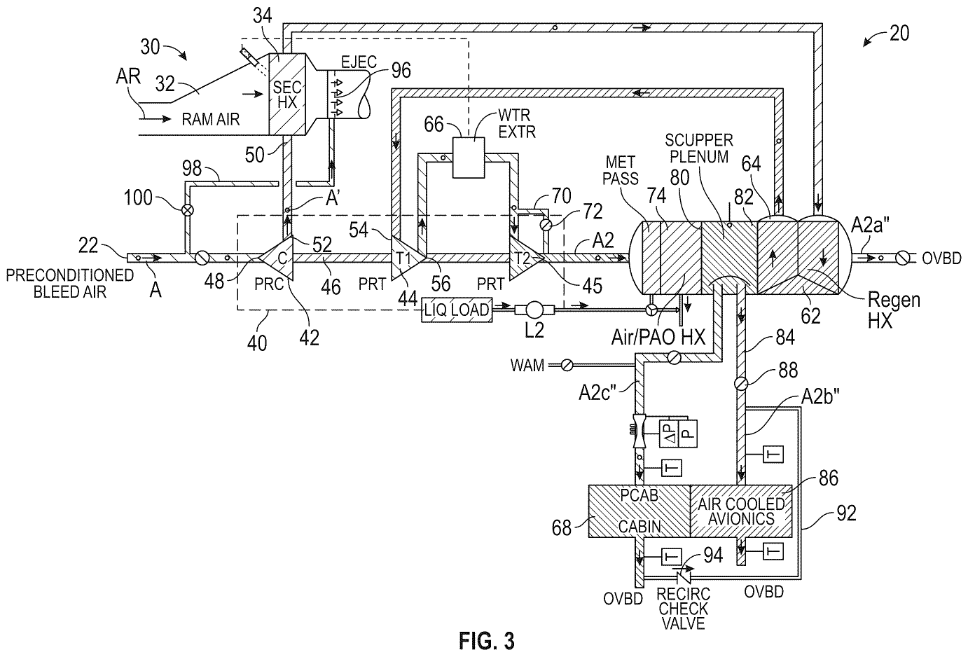

Referring now to FIG. 3, another embodiment of ECS 20 is illustrated. In this embodiment, the position of and the flow of medium to the regeneration heat exchanger 62 is changed, relative to the embodiment of FIG. 1. This provides a higher exhaust temperature from the regeneration heat exchanger 62. In the embodiment of FIG. 3, the cooled compressed medium A′ output from the heat exchanger 34 is directed to the first inlet of the regeneration heat exchanger 62, and out of the first outlet of the regeneration heat exchanger 62. This cooled compressed medium A′ is directed to the first turbine 44 via the first turbine inlet 54 and exits the first turbine 44 via the first turbine outlet 56. From the first turbine outlet 56, the medium is directed through water extractor 66 to remove moisture therefrom. From the water extractor 66, the medium A′ is directed through the second turbine 45 for additional expansion and cooling, and is output from the second turbine 45 as expanded medium A2. The medium A2 is then passed through at least one air-liquid heat exchanger 74 and into plenum 82. From the plenum 82, a first portion A2a″ is directed through the second inlet of the regeneration heat exchanger 62 before being exhausted overboard. The second portion A2b″ is directed from the plenum 82 to the one or more loads 86, while a third portion A2c″ is directed from the plenum 82 to the cabin 68.

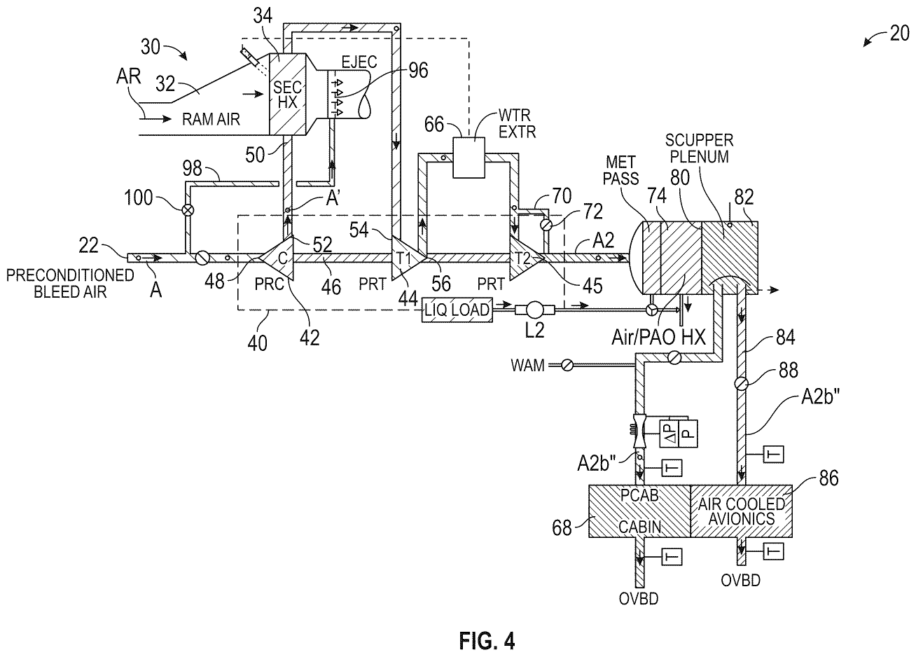

Another embodiment of an ECS 20 is illustrated in FIG. 4. In this embodiment, relative to the others described herein, the regeneration heat exchanger 62 is eliminated in, for example, cases where bleed flow or the flow of medium A into the inlet 22 is limited. In the embodiment of FIG. 4, the flow of the compressed medium A′ exiting the heat exchanger 34 is directed to the first turbine 44 via the first turbine inlet 54 and exits the first turbine 44 via the first turbine outlet 56. From the first turbine outlet 56, the medium is directed through water extractor 66 to remove moisture therefrom. From the water extractor 66, the medium A′ is directed through the second turbine 45 for additional expansion and cooling, and is output from the second turbine 45 as expanded medium A2. The medium A2 is then passed through at least one air-liquid heat exchanger 74 and into plenum 82. From the plenum 82, a first portion A2a″ is directed from the plenum 82 to the one or more loads 86, while a second portion A2b″ is directed from the plenum 82 to the cabin 68.

The configurations of ECS 20 disclosed herein utilize two turbine stages 44 and 45, which allows for effective operation of the ECS 20 in higher bleed pressure situations. The disclosed configurations leverage the higher expansion ratio, and will not yield too high pressure ratio on a single turbine stage. Also this allows for the recirculation of cabin outflow to the avionics bay without utilization of a typical recirculation fan, due to the pressure difference between cabin and avionics bay.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An environmental control system of a vehicle comprising:
an inlet configured to receive a medium;
an outlet for receiving a conditioned form of the medium, wherein a first portion of the conditioned form of the medium at the outlet is to be provided to a cabin of the vehicle; and
a thermodynamic device in fluid communication with the inlet, the thermodynamic device including:
a compressor;
a first turbine; and
a second turbine;
wherein the compressor, the first turbine and the second turbine are operably coupled by a shaft; and
wherein the compressor, the first turbine and the second turbine are fluidly connected such that at least a portion of the medium is provided to the compressor, the first turbine and the second turbine in series; and
further comprising an air-liquid heat exchanger disposed fluidly downstream of the second turbine such that the medium output from the second turbine exchanges thermal energy with a flow of liquid at the liquid-air heat exchanger; and
wherein the first portion of the medium is output to the cabin downstream of the liquid-air heat exchanger.

2. The environmental control system of claim 1, wherein the outlet and the second turbine are arranged in parallel relative to a flow of the medium, and the flow of the medium at a location downstream from the second turbine is configured as a heat sink to cool the medium to be provided to the cabin.

3. The environmental control system of claim 1, wherein a second portion of the medium is output to one or more vehicle loads.

4. The environmental control system of claim 3, further comprising a recirculation passage configured to direct at least a portion of the first portion of the medium from the cabin to the one or more vehicle loads.

5. The environmental control system of claim 1, further comprising a heat exchanger disposed fluidly downstream of the compressor and upstream of the first turbine, such that the medium exiting the compressor exchanger is directed through the heat exchanger for thermal energy exchange with a second medium.

6. The environmental control system of claim 5, further comprising one of a fan or an ejector to urge the second medium across the heat exchanger.

7. The environmental control system of claim 5, further comprising a regeneration heat exchanger through which the medium is directed, the regeneration heat exchanger disposed fluidly downstream of at least the heat exchanger.

8. The environmental control system of claim 7, wherein the regeneration heat exchanger is disposed fluidly between the first turbine and the second turbine.

9. The environmental control system of claim 8, wherein a first portion of the medium output from the regeneration heat exchanger is directed to the second turbine, and a second portion of the medium output from the regeneration heat exchanger is directed to the cabin via a cabin heat exchanger.

10. The environmental control system of claim 1, further comprising a water extractor disposed between the first turbine and the second turbine.

11. The environmental control system of claim 1, further comprising:
a first turbine bypass passage configured to selectably direct the medium to bypass the first turbine; and
a second turbine bypass passage configured to selectably direct the medium to bypass the second turbine.

12. A method of operating an environmental control system of a vehicle, comprising:
receiving a medium at an inlet;
directing the medium from the inlet through a thermodynamic device in fluid communication with the inlet, the thermodynamic device including:
a compressor;
a first turbine; and
a second turbine;
wherein the compressor, the first turbine and the second turbine are operably coupled by a shaft; and
providing at least a portion of the medium to the compressor, the first turbine and the second turbine in series; and
thermally conditioning the medium output from the second turbine at an air-liquid heat exchanger disposed fluidly downstream of the second turbine such that the medium output from the second turbine exchanges thermal energy with a flow of liquid at the liquid-air heat exchanger; and
outputting the first portion of the medium to the cabin downstream of the liquid-air heat exchanger.

13. The method of claim 12, further comprising:
dividing the medium such that a first portion of the medium is provided to an outlet and a second portion of the medium is provided to a turbine in parallel; and
cooling the first portion of the medium with the second portion of the medium at a location downstream from the turbine.

14. The method of claim 12, wherein a second portion of the medium is output to one or more vehicle loads.

15. The method of claim 14, further comprising directing at least a portion of the first portion of the medium from the cabin to the one or more vehicle loads via a recirculation passage.

16. The method of claim 12, further comprising directing the medium through a heat exchanger disposed fluidly downstream of the compressor and upstream of the first turbine, such that the medium exiting the compressor exchanger is directed through the heat exchanger for thermal energy exchange with a second medium.

17. The method of claim 16, further comprising urging the second medium across the heat exchanger via one of a fan or an ejector.

18. The method of claim 16, directing the medium through a regeneration heat exchanger, the regeneration heat exchanger disposed fluidly downstream of at least the heat exchanger.

19. The method of claim 18, wherein the regeneration heat exchanger is disposed fluidly between the first turbine and the second turbine.

20. The method of claim 19, further comprising directing a first portion of the medium output from the regeneration heat exchanger to the second turbine, and directing a second portion of the medium output from the regeneration heat exchanger to the cabin via a cabin heat exchanger.
